(19) United States
(12) Patent Application Publication
(10) Pub. No.: US 2025/0343577 A1
(43) Pub. Date: Nov. 6, 2025

(54) SYSTEMS AND METHODS FOR OVER-THE-AIR INTERFEROMETER BASED MODULATION

(71) Applicant: Huawei Technologies Co., Ltd., Shenzhen (CN)

(72) Inventors: Ahmad ABU AL HAIJA, Ottawa (CA); Mohammadhadi BALIGH, Ottawa (CA)

(21) Appl. No.: 18/961,972

(22) Filed: Nov. 27, 2024

Related U.S. Application Data
(63) Continuation of application No. PCT/CN2022/096547, filed on Jun. 1, 2022.

(51) Int. Cl. H04B 7/04

(52) U.S. Cl. CPC H04B 7/04013

(57) ABSTRACT

Aspects of the present disclosure provide an over-the-air (OTA) interferometer that enables redirecting, by a reconfigurable intelligent surface (RIS) to a destination, a signal that impinges the RIS at each of a plurality of time slots, thereby modulating the signal. The RIS is virtually divided into a plurality of RIS portions. In each time slot, phase components to be applied to the plurality of RIS portions are determined based on one or more phase values. The phase values may include an underlying phase related to redirecting a source signal, an additional phase related to data that an input operatively connected to the RIS aims to transmit to the destination by modulating the signal being redirected, and/or a further phase related to interference patterns that can help extract the data phase at the destination. The destination may demodulate the received signals based on the signal strength measurements.

### CROSS REFERENCE

This application is a continuation of International Application No. PCT/CN2022/096547, filed on Jun. 1, 2022, the disclosure of which is hereby incorporated by reference in its entirety.

### TECHNICAL FIELD

The present disclosure relates generally to wireless communications, and in particular embodiments, an over-the-air (OTA) interferometer based modulation in a wireless communication system.

### BACKGROUND

In some wireless communication systems, user equipments (UEs) wirelessly communicate with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication between two UEs without passing through a base station is referred to as a sidelink (SL) communication or device-to-device (D2D) communication.

Resources are required to perform UL, DL and SL communications. For example, a base station may wirelessly transmit data, such as a transport block (TB), to a UE in a DL transmission at a particular frequency and over a particular duration of time. The frequency and time duration used are examples of resources.

Along with high frequency and sub-terahertz (sub-THz) communication, reconfigurable intelligent surface (RIS) has recently received heightened research interest as potentially being a key enabler for future wireless networks to meet requirements of high data rate and high bandwidth. The RIS consists of an array of configurable elements that can manipulate the phase of signals that are redirected by the RIS. For example, a RIS element can manipulate the phase of an incident wave/signal to redirect the signal in a given direction. Such manipulations can be achieved by configuring the RIS elements via bias voltages (or other methods like mechanical deformation and phase change materials), that are controlled by a control circuit connected to the RIS.

In addition to redirecting a source signal, the RIS elements, due to their ability to manipulate the phase, amplitude, and frequency of the incident signal, may be utilized, for example by a sensor, to modulate the incident signal, overlay sensor data over a signal for another source (e.g., base station) and forward the modulated/overlaid signal to a destination. Such modulation technique is known as media-based modulation (MBM).

However, many UEs have less complex circuitry (e.g., UE with simple envelop detector and a single radio frequency chain (RFC)) and have limited capabilities (e.g., simple measurements of the signal strength) which may be unable to estimate channel phase, perform coherent detection or measure in-phase and quadrature components of the signals that are received, therefore, such MBM technique is not feasible for the UEs.

### SUMMARY

Aspects of the present disclosure provide an over-the-air (OTA)-interferometer based modulation technique that enables modulating an incident signal impinging the RIS. The OTA-interferometer based modulation technique supports data received from an input (e.g., sensor) operatively connected to the RIS to transmit the data to a destination (e.g., UE). In some embodiments, an OTA interferometer is utilized to compare multiple signals, for example, in terms of phase, frequency or signal strength. A general design of the OTA interferometer enables transmitting one or more signals to a destination over multiple time-frequency resources. The time-frequency resource may be multiple time slots allocated for data transmission between a source and a destination. It should be noted that while terms like ‘time-slot’ or ‘slot’ are used in the present disclosure, other time-frequency resources may be instead used. In each time-frequency resource (e.g., time slot), phases of one or more signals may be modified or modulated using OTA-interferometer based modulation techniques. Signal strength measurements (or power measurement) may be performed at the destination (e.g., receiver) during multiple time slots and used to determine a phase difference between the signals received at the destination. Examples of different types of source and destination include devices such as a base station, an access point (AP), a transmit receive point (TRP) and user equipment (UE). While specific examples utilizing an OTA-interferometer based modulation are described below with a particular number of devices, types of communication (DL, UL, SL) and time-frequency resources (time slots) for particular applications, it should be noted that the concepts generally described herein may be used for different numbers of devices, types of communications, and time-frequency resources for other applications that may benefit from use of the proposed OTA interferometer.

According to an aspect of the disclosure there is provided a method for supporting data transmission in a wireless network involving: receiving, by a reconfigurable intelligent surface (RIS), data for modulating a signal that impinges the RIS during each of a plurality of time slots, wherein the RIS is divided into a plurality of RIS portions. For each of the plurality of time slots, the method further involves determining phase components to be applied to the plurality of RIS portions, wherein at least one of the phase components to be applied to at least one RIS portion includes a first phase value for redirecting the signal from a transmitter to a receiver and a second phase value dependent on the data; and applying the phase components to the plurality of RIS portions. The method further involves redirecting the signal that impinges the RIS at each of the plurality of time slots.

Further, by using the above method, the device may modulate the data onto the signal.

Optionally, maybe the datα is from an input operatively connected to the RIS.

In some embodiments, the determining the phase components includes adding a third phase value independent of the data that is different in each of the plurality of time slots. In some embodiments, the third phase value is added to the at least one RIS portion or at least one other RIS portion of the plurality of RIS portions. In some embodiments, when the number of time slots in the plurality of time slots is four, the third phase value in the plurality time slots is equal to zero in a first time slot, π/2 in a second time slot, π in a third time slot and 31/2 in a fourth time slot.

In some embodiments, the method further involves receiving, by the RIS, configuration information for controlling the RIS during the plurality of time slots from a base station. In some embodiments, the configuration information further includes one or more of: first phase information for one or more RIS elements in each of the plurality of RIS portions a number of portions in the plurality of RIS portions; a number of time slots in the plurality of time slots; information related to the signal that impinges the RIS at each of the plurality of time slots; a modulation scheme that can be decoded by the UE; phase shift information for use in modifying phase values of at least one of the plurality of RIS portions with respect to at least one other of the plurality of RIS portions in each of the plurality of time slots; and a relative size of each of the plurality of RIS portions.

In some embodiments, the second phase value is based on the data being encoded using M-ary phase shift keying (MPSK).

In some embodiments, the method further involves modifying a relative size of each of the plurality of RIS portions for the plurality of time slots, thereby modulating amplitude of the signal. In some embodiments, the relative size of each of the plurality of RIS portions and the second phase value are based on the data being encoded using quadrature amplitude modulation (QAM).

In some embodiments, each of the plurality of RIS portions includes a plurality of elements and each of the plurality of elements have a respective phase component applied to the element that is different than adjacent elements.

According to an aspect of the disclosure there is provided a device supporting data transmission in a wireless network including a processor and a computer-readable medium. The computer-readable medium has stored thereon computer executable instructions that when executed cause the processor to perform a method consistent with the embodiment described above.

According to an aspect of the disclosure there is provided a method involving receiving, by a user equipment (UE), during each of a plurality of time slots, a plurality of signals, each signal being redirected by a portion of a reconfigurable intelligent surface (RIS) that is divided into a plurality of RIS portions, wherein a signal of the plurality of signals is modulated by a phase component, which includes a first phase value, when the signal is redirected by at least one RIS portion. The method further involves measuring, by the UE, signal strength of the received plurality of signals at each of a plurality of time slots. The method further involves determining, by the UE, based on the measured signal strengths of the received plurality of signals at each of the plurality of time slots, where the first phase value modulates the signal of the plurality of signals.

In some embodiments, the phase component used to modulate the signal redirected by the at least one RIS portion includes the first phase value, which is a same phase in all of the plurality of time slots, and a second phase value that is different in each of the plurality time slots. In some embodiments, a phase component of another signal of the plurality of signals, which is redirected by at least one other of the RIS portions, includes a second phase value that is different in each of the plurality time slots. In some embodiments, when the number of time slots in the plurality of time slots is four, the second phase value in the plurality time slots is equal to zero in a first time slot, π/2 in a second time slot, a in a third time slot and 31/2 in a fourth time slot.

In some embodiments, the method further involves receiving, by the UE, configuration information for measuring the received plurality of signals via radio resource control (RRC) signaling. In some embodiments, the configuration information includes one or more of: a number of portions in the plurality of RIS portions; a number of time slots in the plurality of time slots; phase shift information for use in modifying phase values of at least one of the plurality of RIS portions with respect to at least one other of the plurality of RIS portions in each of the plurality of time slots; a decoding rule for determining the phase value modulated on the plurality of signals based on the measured signal strengths of each of the received plurality of signals at each of the plurality of time slots; a modulation scheme that can be decoded by the UE; information related to periodic pilot or reference signal transmission for RIS configuration update or destination phase compensation and decoding rule; and information related to periodic pilot transmission for interference patterns associated with each of the received plurality of signals at each of the plurality of time slots.

In some embodiments, the first phase value is encoded using MPSK.

In some embodiments, an amplitude of at least one of the plurality of signals is modulated by the RIS during the plurality of time slots. In some embodiments, the amplitude of the at least one of the plurality of signals is modulated by a relative size of each of the plurality of RIS portions during the plurality of time slots. In some embodiments, the relative size of each of the plurality of RIS portions and the first phase value are based on data being encoded using QAM.

According to an aspect of the disclosure there is provided a device supporting data transmission in a wireless network including a processor and a computer-readable medium. The computer-readable medium has stored thereon computer executable instructions that when executed cause the processor to perform a method consistent with the embodiment described above.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a 6 port interferometer having two inputs and four outputs.

FIG. 2 is a schematic diagram of a transmission channel between a source and destination in which a planar array of configurable elements is used to redirect signals according to an aspect of the disclosure.

FIG. 3A is a schematic diagram of a communication system in which embodiments of the disclosure may occur.

FIG. 3B is another schematic diagram of a communication system in which embodiments of the disclosure may occur.

FIG. 4A is a block diagram illustrating units or modules in a device in which embodiments of the disclosure may occur.

FIG. 4B is a block diagram of an example reconfigurable intelligent surfaces (RIS).

FIG. 5 is a block diagram illustrating units or modules in a device in which embodiments of the disclosure may occur.

FIG. 6 is a block diagram illustrating a network where a reconfigurable intelligent surface (RIS) is operatively connected to an input that aims to send data from the input to a destination with assistance of a signal from a source.

FIG. 7A is a block diagram illustrating a RIS divided into two separate RIS portions, each of which is comprised of one or more RIS elements, in accordance with embodiments of the present disclosure.

FIG. 7B is a schematic diagram illustrating how two separate portions of a RIS redirect signals between a base station and a UE over four time slots, in accordance with embodiments of the present disclosure.

FIG. 7C is an example of an 8-PSK (phase shift keying) constellation diagram that may be used by a RIS to modulate a symbol on a signal from a base station in accordance with embodiments of the present disclosure.

FIG. 7D illustrates an example of phase values applied to RIS elements in each of four time slots, in accordance with embodiments of the present disclosure.

FIGS. 8A to 8C are schematic diagrams each illustrating an example of a 16 Quadrature Amplitude Modulation (QAM) constellation diagram and configuration of a RIS over four time slots that enables modulation of a particular symbol or constellation in the constellation diagram by the RIS, in accordance with embodiments of the present disclosure.

FIG. 9 is a schematic diagram illustrating two unequally divided RIS portions of a RIS for a particular time slot used in OTA interferometer-base modulation, in accordance with embodiments of the present disclosure.

FIG. 10 is a schematic diagram illustrating three time slot transmission using variously divided RIS portions, in accordance with embodiments of the present disclosure.

FIG. 11 is an example of a signaling flow diagram for signaling between a base station, a UE, and an RIS that enables operation of an OTA interferometer, in accordance with embodiments of the present disclosure.

FIG. 12 is a schematic diagram illustrating two equally divided RIS portions of a RIS for a particular time slot used in OTA interferometer-base modulation that is used to communicate with multiple UEs, in accordance with embodiments of the present disclosure.

### DETAILED DESCRIPTION OF THE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

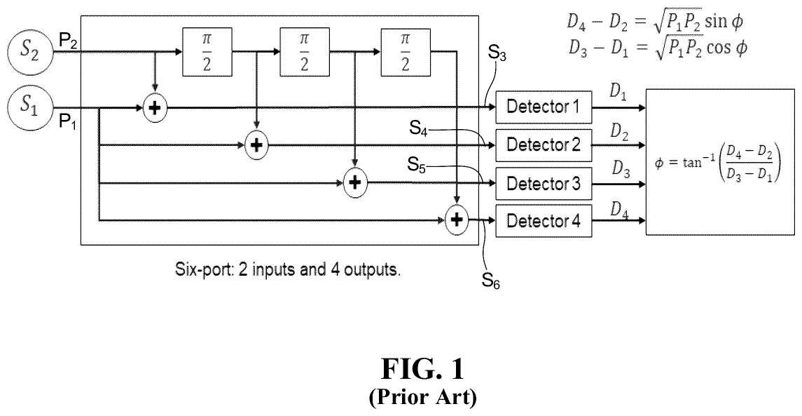

A 6-port interferometer is a common type of multiport structure. FIG. 1 illustrates an example of a 6-port interferometer that has two inputs S₁ and S₂ and four outputs S₃, S₄, S₅ and S₆ for a total of 6-ports. The 6-port interferometer compares the first input S₁ with different instances of the second input S₂ that have been phase shifted, or modified, with respect to one another. For example, a first output S₃ is a result of superimposing the first input S₁ with the second input S₂, a second output S₄ is a result of superimposing the first input S₁ with the second input S₂ that has been phase shifted by a first phase shifteπ by π/2, a third output S₅ is a result of superimposing the first input S₁ with the second input S₂ that has been phase shifted by a total of π by the first phase shifter and a second phase shift by another π/2, and a fourth output S₆ is a result of superimposing the first input S, with the second input S₂ that has been phase shifted by a total of 31/2 by the first and second phase shifters and a third phase shift by another π/2. In the example of FIG. 1, four detectors are used to measure the power of the four superimposed signals from outputs S₃, S₄, S₅ and S₆ in the form of detected values D₁, D₂, D₃, and D₄. The detected values D₁, D₂, D₃, and D₄ satisfy D₃−D₁=4\sqrt{P₁P₂} cos ϕ and D₄−D₂=4\sqrt{P₁P₂} sin ϕ. From these equations, the phase difference between the two inputs S₁ and S₂ can be determined based on the expression

$$ϕ = {tan}^{- 1} \frac{{D}_{4} - {D}_{2}}{{D}_{3} - {D}_{1}} ,$$

for example py a microprocessor (uC).

As the interferometer and similar multiport devices include the functionality of adding controlled phase shifts to one or more signals, a possible technology that is capable of phase modification and may be used to implements the phase addition is a reconfigurable intelligent surface (RIS). The RIS consists of an array of elements that can change the phase (and also amplitude, polarization, or even the frequency) of an incident wave/signal. Such changes are achieved by configuring the RIS elements via bias voltages (or other methods like mechanical deformation and phase change materials), that are controlled by a control circuit connected to the RIS.

Because of low cost implementation and the ability to perform accurate measurements, devices such as the 6-port interferometer illustrated in FIG. 1 may be utilized for multiple different types of applications in telecommunication networks including, carrier frequency offset (CFO) estimation, phase noise measurements, localization and distance measurements, and modulation and demodulation techniques. Such devices are typically implemented in the form or a physical circuit structure in a transmitter, receiver or transceiver.

However, an interferometer such as the 6-port interferometer shown in FIG. 1 typically has a specific receiver structure regardless of how simple the design is. For example, to improve the performance of the 6-port interferometer, calibration may be needed for the detectors so that they have identical or substantially the same performance.

In an attempt to simplify operation at the receiver, aspects of the disclosure provide using interferometry by modifying transmission signals from active nodes, such as base station, access nodes or user equipment, to simplify the receiver circuit design. Implementation of an interferometer design according to aspects of the disclosure will be being referred to as an over-the-air (OTA) interferometer. The OTA may perform a similar functionality to that of a physical circuit design, but is applied to transmission signals between devices in a communication network over the air. Some embodiments of the disclosure include use of an RIS to enable a phase shift in the OTA between two signals transmitted between two active nodes. Some embodiments of the disclosure include use of a relay to enable a phase shift in the OTA between two signals transmitted between two active nodes. Some embodiments of the disclosure include use of OTA to enable coherent transmission between communication signals transmitted between two active nodes via multiple paths.

Aspects of the disclosure may also provide methods of signaling associated with the OTA interferometer for various different applications such as, but not limited to fine configuration at the RIS, e.g., fine estimation of an angle of arrival (AoA) and/or angle of departure (AoD) at the RIS, and coherent transmission for downlink (DL), uplink (UL), relaying, and multi-transmit receive point (TRP) transmission.

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize “smart radio environment” or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds the environment information that has been sensed back to the system. According to this information, the system may optimize transmission mode parameters and RIS parameters through smart radio channels, at one or more of the transmitter (whether the base station or a UE), the channel and the receiver (whether the UE or a base station).

Because of beamforming gains associated with RISs, exploiting smart radio channels may significantly improve one or more of link quality, system performance, cell coverage, and cell edge performance in wireless networks. Not all RIS panels use the same structure. Different RIS panels may be designed with different types of phase adjusting capabilities that range from continuous phase control, to discrete control with multiple levels.

Another application of RISs is in transmitters that directly modulate incident radio one or more wave properties, such as phase, amplitude polarization and/or frequency without a need for active components as used in RF chains in traditional multiple input multiple output (MIMO) transmitters. RIS based transmitters have many merits, such as simple hardware architecture, low hardware complexity, low energy consumption and high spectral efficiency. Therefore, RISs provide a new direction for extremely simple transmitter design in future radio systems.

RIS assisted MIMO also may be used to assist fast beamforming with the use of accurate positioning, or to conquer blockage effects through CSI acquisition in mmWave systems. Alternatively, RIS assisted MIMO may be used in non-orthogonal multiple access (NOMA) in order to improve reliability at very low signal to noise ratio (SNR), accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial and controllable nodes is an important paradigm shift in MIMO system, such as 6G MIMO. Such controllability is in contrast to the traditional communication paradigm, where transmitters and receivers adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as user distribution and traffic patterns change over time. This involves utilizing high altitude pseudo satellites (HAPs), unmanned aerial vehicles (UAVs) and drones when and where it is necessary.

RIS-assisted MIMO utilizes RISs to enhance the MIMO performance by creating a smart radio channel. To extract full potential of RIS-assisted MIMO, a system architecture and more efficient scheme are provided in the present disclosure.

An RIS may include many small reflection elements, often comparable in size with the wavelength (for example, from 1/10 to a couple of wavelengths). Each element can be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to two or three dimensional arrangements (e.g., circular array). A linear array is a vector of N configurable elements and a planar array is a matrix of N×M configurable elements, where N and M are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

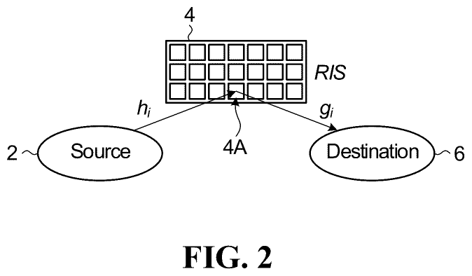

Because of their ability to manipulate the incident wave/signal, the low cost of these types of RIS, and because these types of RIS require small bias voltages, RIS have recently received heightened research interest in the area of wireless communication as a valuable tool for beamforming and/or modulating communication signals. A basic example for RIS utilization in beamforming is shown in FIG. 2 where each RIS configurable element 4a (unit cell) can change the phase of the incident wave from source such that the reflected waves from all of the RIS elements are aligned to the direction of the destination to increase or maximize its received signal strength (e.g., maximize the signal to noise ratio). Such a reflection via the RIS may be referred to as reflect-array beamforming. In some embodiments, the planar array of configurable elements, which may be referred to as an RIS panel, can be formed of multiple RIS sub-panels or portions or the RIS panel. In some embodiments, the RIS can be considered as an extension of the BS antennas or a type of distributed antenna. In some embodiments, the RIS can also be considered as a type of passive relay.

Aspects of the present disclosure provide methods and device for utilizing RIS panels in the wireless network to take advantage of the RIS capabilities, intelligence, coordination and speed, and thereby propose solutions having different signaling details and capability requirements.

FIG. 2 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as hᵢ and a channel between the RIS 4 and destination 6 identified as gᵢ for the i^{th} RIS configurable element (configurable element 4a) where i ∈{1,2,3, . . . , N*M} assuming the RIS consists of N*M elements or unit cells. A wave that leaves the source 2 and arrives at the RIS 4 can be said to be arriving with a particular AoA. When the wave is reflected or redirected by the RIS 4, the wave can be considered to be leaving the RIS 4 with a particular AoD. In some embodiments, the planar array of configurable elements, which may be referred to as an RIS panel, can be formed of multiple co-planar RIS sub-panels. In some embodiments, the RIS can be considered as an extension of the BS antennas or a type of distributed antenna. In some embodiments, the RIS can also be considered as a type of passive relay.

While FIG. 2 has two dimensional planar array RIS 4 and shows a channel hᵢ and a channel gᵢ, the figure does not explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

In wireless communications, the RIS 4 can be deployed as 1) a reflector between a transmitter and a receiver, as shown in FIG. 2, or as 2) a transmitter (integrated at the transmitter) to help implement a virtual MIMO system as the RIS helps to direct the signal from a feeding antenna.

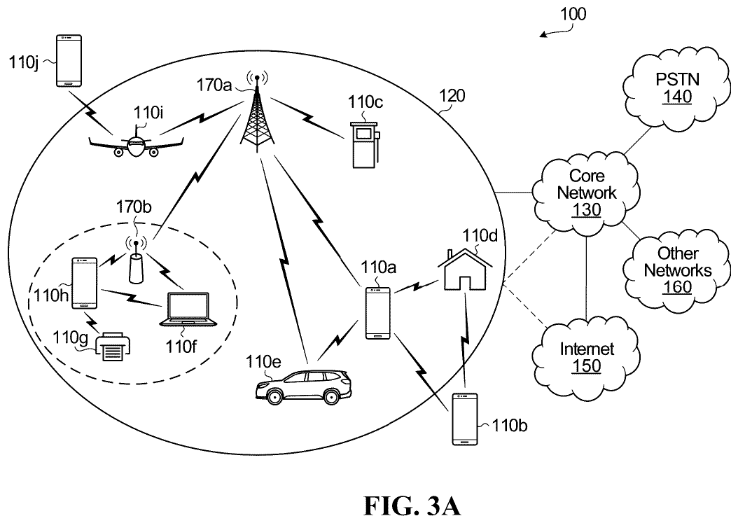

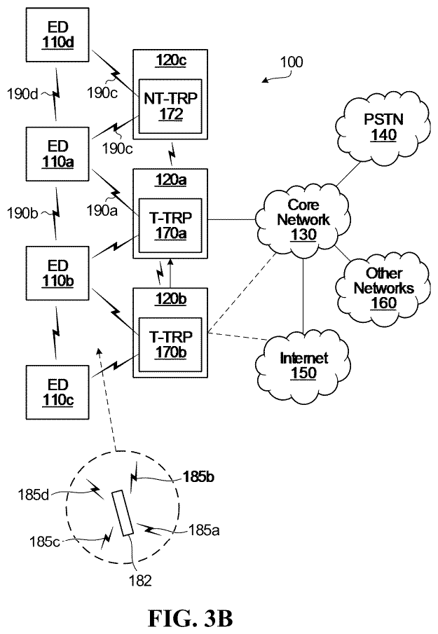

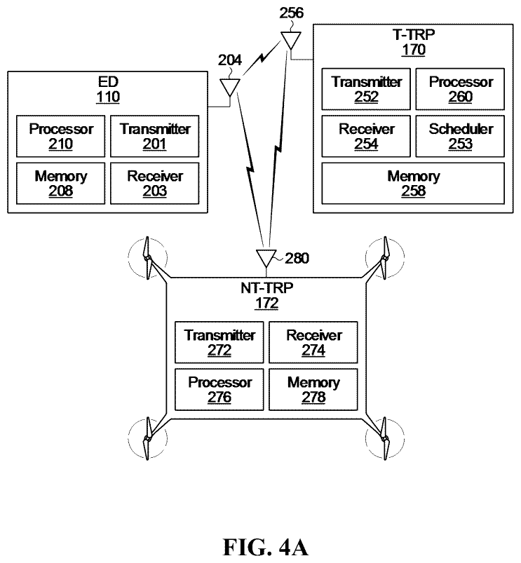

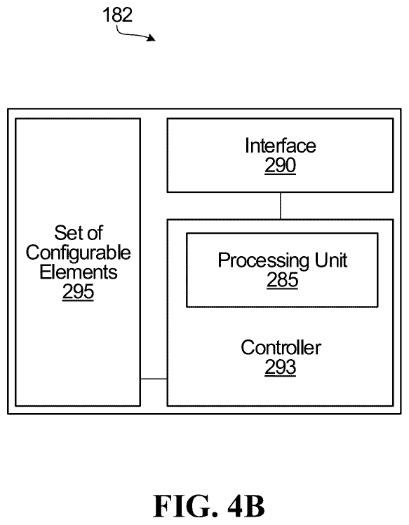

FIGS. 3A, 3B, 4A and 4B following below provide context for the network and device that may be in the network and that may implement aspects of the present disclosure.

Referring to FIG. 3A, as an illustrative example without limitation, a simplified schematic illustration of a communication system is provided. The communication system 100 comprises a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 3B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 3B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 3B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 3B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 3B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 3B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g., radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b, 172 may establish an air interface 190a, 190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g., radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

Also shown in FIG. 3B is a RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 3B, it is to be understood that any number of RIS could be included in a network.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 4A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 4A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly oπ by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIGS. 3A or 3B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g., beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g., in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g., communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g., BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g., in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g., in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 4A. FIG. 4A illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 4A, a RIS may be located between the ED 110 and the NT-TRP 172 or between the ED 110 and the T-TRP 170, in a similar manner as RIS 182 is shown between the EDs 110 and base station 170b in FIG. 3B. A RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

FIG. 4B illustrates an example RIS device that may implement the methods and teachings according to this disclosure. In particular, FIG. 4B illustrates an example RIS device 182. These components could be used in the system 100 shown in FIGS. 3A and 3B, the system shown in FIG. 4A, or in any other suitable system.

As shown in FIG. 4B, the RIS device 182, which may also be referred to as a RIS panel, includes a controller 293 that includes at least one processing unit 285, an interface 290, and a set of configurable elements 295. The set of configurable elements are arranged in a single row or a grid or more than one row, which collectively form the reflective surface of the RIS panel. The configurable elements can be individually addressed to alter the direction of a wavefront that impinges on each element. RIS reflection properties (such as beam direction, beam width, frequency shift, amplitude, and polarization) are controlled by RF wavefront manipulation that is controllable at the element level, for example via the bias voltage at each element to change the phase of the reflected wave. This control signal forms a pattern at the RIS. To change the RIS reflective or redirecting behavior, the RIS pattern needs to be changed.

Connections between the RIS and a UE can take several different forms. In some embodiments, the connection between the RIS and the UE is a reflective channel where a signal from the BS is reflected, or redirected, to the UE or a signal from the UE is reflected to the BS. In some embodiments, the connection between the RIS and the UE is a reflective connection with passive backscattering or modulation. In such embodiments a signal from the UE is reflected by the RIS, but the RIS modulates the signal by the use of a particular RIS patter. Likewise, a signal transmitted from the BS may be modulated by the RIS before it reaches the UE. In some embodiments, the connection between the RIS and the UE is a network controlled sidelink connection. This means that that the RIS may be perceived by the UE as another device like a UE, and the RIS forms a link similar to two UEs, which is scheduled by the network. In some embodiments, the connection between the RIS and the UE is an ad hoc in-band/out-of-band connection.

A RIS device, also referred to as a RIS panel, is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system.

The processing unit 285 implements various processing operations of the RIS 182, such as receiving the configuration signal via interface 290 and providing the signal to the controller 293. The processing unit 285 could, for example, include a microprocessor, microcontroller, digital signal processor, field programmable gate array, or application specific integrated circuit.

While this is a particular example of an RIS, it should be understood that the RIS may take different forms and be implemented in different manner than shown in FIG. 4B. The RIS 182 ultimately needs a set of configurable elements that can be configured as described to operate herein.

FIG. 4B illustrates an interface 290 to receive configuration information from the network. In some embodiments, the interface 290 enables a wired connection to the network. The wired connection may be to a base station or some other network-side device. In some embodiments, the wired connection is a propriety link, i.e. a link that is specific to a particular vendor or supplier of the RIS equipment. In some embodiments, the wired connection is a standardized link, e.g., a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or with the UE. In some embodiments, the wireless connection is an in-band propriety link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with the base station. In some embodiments, the transceiver is an integrated transceiver such as an LTE, 5G, or 6G transceiver for low rate communication. In some embodiments, the interface could be used to connect a transceiver or sensor to the RIS.

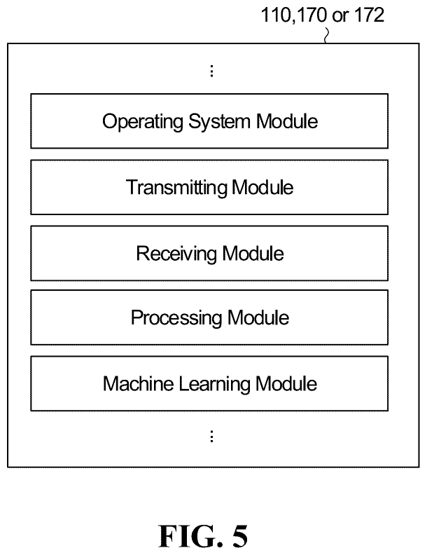

One or more steps of the embodiment methods provided herein may be performed by corresponding units or modules, according to FIG. 5. FIG. 5 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g., intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

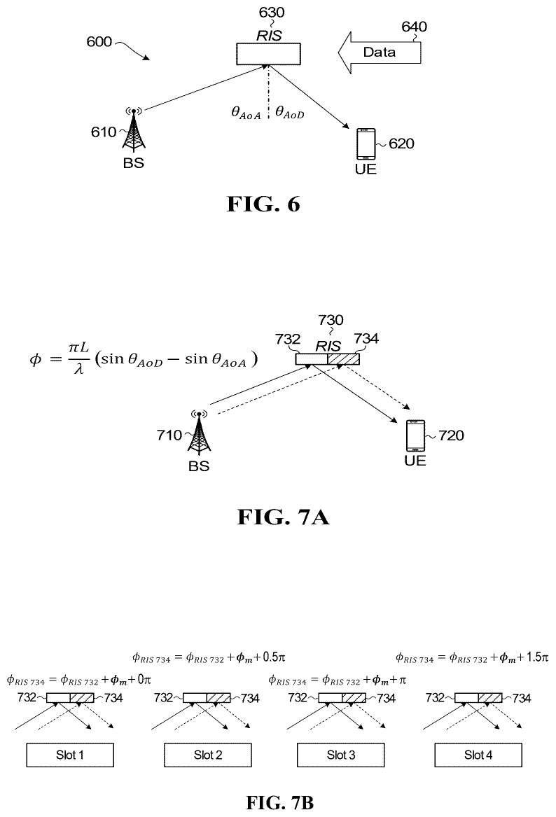

Aspects of the present disclosure provide a method and devices for supporting transmission of data (e.g., data from an input connected to an RIS) to a destination using modulation techniques such as M-ary phase shift keying (MPSK) and quadrature amplitude modulation (QAM). The data to be sent to a destination (e.g., UE) is encoded as a sequence of multiple time slot transmission using interference patterns associated with signals modulated and/or redirected by the RIS. Embodiments of the present disclosure and the associated techniques may be particularly considered in circumstances like the scenario illustrated in FIG. 6. FIG. 6 illustrates a wireless network 600 where an RIS 630 is operatively connected to an input (e.g., sensor; not shown in FIG. 6) that aims to send data 640 to a UE 620 by modulating a signal (e.g., carrier signal) from a source, such as the base station 610 when the RIS is redirecting the signal. In the wireless network 600, the UE 620 has a simple receiver with limited capabilities, such as envelope detector, that is capable of recovering the data modulating on the signal.

Aspects of the present disclosure provide an OTA-interferometer based modulation technique that enables modulating an incident signal impinging the RIS. The OTA-interferometer based modulation technique supports data received from an input (e.g., sensor) operatively connected to the RIS to transmit the data to a destination (e.g., UE). In some embodiments, an OTA interferometer is utilized to compare multiple signals, for example, in terms of phase, frequency or signal strength. A general design of the OTA interferometer enables transmitting one or more signals to a destination over multiple time-frequency resources. The time-frequency resource may be multiple time slots allocated for data transmission between a source and a destination. It should be noted that while terms like ‘time-slot’ or ‘slot’ are used in the present disclosure, other time-frequency resources may be instead used. In each time-frequency resource (e.g., time slot), phases of one or more signals may be modified or modulated using OTA-interferometer based modulation techniques. Signal strength measurements (or power measurement) may be performed at the destination (e.g., receiver) during multiple time slots and used to determine a phase difference between the signals received at the destination. Examples of different types of source and destination include devices such as a base station, an access point (AP), a transmit receive point (TRP) and user equipment (UE). While specific examples utilizing an OTA-interferometer based modulation are described below with a particular number of devices, types of communication (DL, UL, SL) and time-frequency resources (time slots) for particular applications, it should be noted that the concepts generally described herein may be used for different numbers of devices, types of communications, and time-frequency resources for other applications that may benefit from use of the proposed OTA interferometer.

In embodiments of the present disclosure, a RIS capable of performing OTA-interferometer based modulation is provided in which the RIS is divided into a plurality of RIS portions, each of which includes one or more RIS elements and redirects the incident signals from a source (e.g., base station) to a destination (e.g., UE).

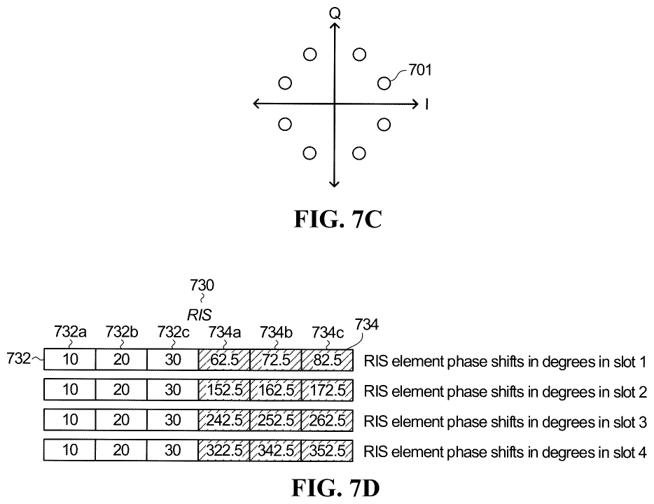

For example, a phase difference between two RIS redirected signals may be used for phase modulation. To modulate the signal that impinges the RIS at each of a plurality of time slots, each of the plurality of RIS portions is controlled or modified in each of the plurality of time slots. For that, the RIS determines phase components to be applied to the plurality of RIS portions. At least one of the phase components is applied to the at least one RIS portion of the plurality of RIS portions. The phase component applied to the at least one RIS portion may comprise a first phase value for redirecting the signal from a transmitter (e.g., base station) to a receiver (e.g., UE) and a second phase value that is dependent on the data received from the input operatively connected to the RIS. The first phase value applied to the RIS enables the RIS to redirect the signal such that the signal leaves the RIS with a particular angle of departure (AoD), as illustrated in FIG. 6. The first phase value may be denoted as ϕ_{d} or ϕ below and elsewhere in the present disclosure. The second phase value is used to modulate the redirected signal based on the data received from the input operatively connected to the RIS, and may be identified as ϕₘ below and elsewhere in the present disclosure. Data at the RIS is used for modulating a signal that impinges the RIS over each of the plurality of time slots. The data used for the signal modulation may be received from an input (e.g., sensor) operatively connected to the RIS. The phase component applied to the at least one RIS portion may further comprise a third phase value used to implement the OTA-interferometer based modulation that is independent of the data. This third phase value would have different values in each time slot. For example, as illustrated below and FIG. 7B, the third phase values are {0, 0.5π, π, 1.5π} in Slot 1, Slot 2, Slot 3 and Slot 4, respectively. The third phase value may be applied to another phase component applied to an RIS portion other than the at least one RIS portion. The third phase may be referred to as the data independent phase value. Further illustration will be provided with respect to the first, second, and third phase values below and elsewhere in the present disclosure.

Upon applying the phase components to the plurality of RIS portions over each of the plurality of time slots, the RIS portions redirect the signal that impinges the RIS at each time slot, thereby modulating the data (i.e. data received from the input connected to the RIS) onto the signal that is being redirected by the RIS.

Further, to control or modulate amplitude of the RIS redirected signals, a relative size of each of the plurality of RIS portions (in comparison to other RIS portions) may be controlled or modified over the plurality of time slots. In some embodiments, the relative size of each of the RIS portions may be determined based on the data received from the input connected to the RIS that is encoded using a modulation technique such as quadrature amplitude modulation (QAM).

The data received from the input operatively connected to the RIS (e.g., data 640 shown in FIG. 6) may be encoded based upon a sequence of different phases of the RIS redirected signals and a relative size of each of the plurality of the RIS portions (e.g., various RIS portion sizes) over the plurality of time slots.

Aspects of the present disclosure provide an OTA-interferometer based modulation technique that supports data transmission in a wireless network using MPSK modulation (e.g., phase modulation) and/or QAM modulation (e.g., amplitude modulation). The OTA-interferometer based modulation technique presented in the present disclosure also enables encoding the data from an input (e.g., sensor) operatively connected to the RIS using different phases of the RIS redirected signals and a relative size of each of the plurality of the RIS portions. Further illustration about the OTA-interferometer based modulation techniques used for data transmission and encoding is provided below or elsewhere in the present disclosure.

In a wireless network such as the network 600 illustrated in FIG. 6, a signal from the base station (BS) 610 can be redirected to the UE 620 or other destination using the reconfigurable intelligent surface (RIS) 630. Without loss of generality, the RIS 630 includes a set of configurable RIS elements arranged in a linear array, where the array length may be denoted as L. It should be noted that a person skilled in the art would readily understand how to extend methods and devices illustrated in the present disclosure to other RIS array structures (e.g., planar array).

Specifically, in the wireless network 600, a source, such as the base station 610, sends signals to a destination, such as the UE 620, via redirection by the RIS 630 using media-based modulation (MBM) technique. Without losing generality, with respect to the azimuth angles (or elevation angles) shown in FIG. 6, θ_{AoD} denotes the angle of departure (AoD) from the RIS 630 to the UE 620 projected to the RIS direction (i.e., angle from the boresight or normal to RIS surface) and 0404 denotes the projected angle of arrival (AoA) from the base station 610 to the RIS 630, as shown in FIG. 6. Referring to FIG. 6, the base station 610 transmits a signal (e.g., carrier signal) in a direction of the RIS 630 and, upon arrival of the signal, the RIS 630 redirects the arrived signal to the UE 620. The signal arriving at the RIS 630 is indicated to arrive at a particular AoA, and the signal that is redirected by the RIS 630 is indicated to depart at a particular AoD. It is the first phase value discussed above in the phase component applied to the RIS that enables the RIS to redirect the signal such that the signal leaves the RIS with the particular AoD.

In order to improve and increase the signal strength (e.g., maximizing the signal-to-noise ratio (SNR)) at the receiver or the UE 610, the phase-difference (ϕ_{d}) between two adjacent RIS elements should satisfy Equation (1) below:

$${ϕ}_{d} = \frac{2 π d}{λ} ( sin {θ}_{AoD} - sin {θ}_{AoA} ) \qquad ( 1 )$$

where d is the distance (or space) between two consecutive RIS elements, A is the wavelength of the transmitted signal, θ_{AoD} is the angle of departure from the RIS 630 to the UE 620 with regard a direction normal to the surface of the RIS 630.

If the input operatively connected to the RIS 630 (not shown in FIG. 6) wants to send data using MPSK modulation and the UE 620 has a simple receiver (e.g., with envelope detector), an OTA-interferometer based modulation technique may be utilized as illustrated below or elsewhere in the present disclosure.

The OTA-interferometer based modulation technique may be used for MPSK modulation. Given that a common 6-port interferometer has 2 inputs and 4 outputs, the 2 inputs of the 6-port interferometer correspond to two signals redirected by the RIS and the 4 outputs of the 6-port interferometer correspond to four time slot transmission and the strength of the signals measured over the four time slots. A symbol ϕₘ may be sent by the RIS by configuring at least a portion of the RIS to modulate the phase of the signal being redirected by the RIS based on the phase component of ϕₘ over the plurality of time slots as illustrated below and FIGS. 7A and 7B. Put another way, Øm represents a phase value that is related to the data that the RIS is to overlay on signal being redirected by the RIS.

In a wireless network illustrated in FIG. 7A, there are a base station (BS) 710, UE 720, and RIS 730. The base station 710, or a network of which the base station 710 is a part, configures the RIS 730 such that the RIS 730 is virtually divided into two or more RIS parts (i.e., two or more RIS portions). The RIS 730 may be virtually divided into equal parts, as shown in FIG. 7A, or into non-equal parts. In FIG. 7A, the RIS 730 is divided into only two RIS portions 732 and 734, where each RIS portion includes one or more RIS elements. The phase difference (+) between the two RIS portions 732 and 734, satisfies Equation (2) below, where L/2 is the spacing between the midpoints of the two adjacent RIS portions:

$$ϕ = \frac{π L}{λ} ( sin {θ}_{AoD} - sin {θ}_{AoA} ) \qquad ( 2 )$$

In some embodiments, the phase difference between adjacent elements that make up the each of the RIS portion may be determined by Equation (2), i.e., where L/2 is the spacing between the midpoints of the two adjacent RIS elements. FIG. 7D shows an example of where there is a 10 degree phase difference between adjacent elements in each of the two RIS portions.

A signal transmitted by the base station 710 that is redirected by each of the two RIS portions 732 and 734 appears subsequent to being redirected by the RIS 730 as two signals with a phase difference between them equal to ϕ, as shown in FIG. 7A. As stated above, the two signals redirected by the two different RIS portions may be considered to generally correspond to the two inputs S₁ and S₂ applied to the 6-port interferometer shown in FIG. 1.

In order to realize the four outputs of the common 6-port interferometer, the base station 710 transmits the signal in four time slots as illustrated in FIG. 7B. FIG. 7B illustrates how two separate and equal sized portions of the RIS 730 redirect signals transmitted from a base station towards a UE over the four time slots.

The phase for each of the RIS elements in the RIS portion 732 can be obtained according to Equation (1) provided above, over each of the four time slots. The phases of the elements of the RIS portion 732 are not further modified, compared to the phases obtained according to Equation (1), in all of Slot 1, Slot 2, Slot 3 and Slot 4. In other words, only a first phase value, which is related to redirecting the signal from a source (e.g., base station) to a destination (e.g., UE), is applied to the RIS elements in the RIS portion 732.

On the other hand, the phases of RIS elements in the RIS portion 734 are further modified. The RIS portion 734 of the RIS 730 has a different additional phase value added in each time slot such that the phase components of the RIS portion 734 during each of the four time slots are different from one another. Specifically, the phases of RIS elements in the RIS portion 734 are obtained according to Equation (1) and increased by a second phase value Øm and further increased by a third phase values {0, 0.5π, π, 1.5π} in Slot 1, Slot 2, Slot 3 and Slot 4, respectively. Therefore, phases for the RIS elements in the RIS portion 734 would be the phase shifts calculated based on the Equation (1) plus ϕₘ in Slot 1, plus ϕₘ+0.5π in Slot 2, plus ϕₘ+π in Slot 3, and plus ϕₘ+1.5π in Slot 4. As noted above, the second phase value ϕₘ represents a phase value that is related to the data received from the input operatively connected to the RIS. The formulas shown in FIG. 7B above each slot illustrate that the phases applied for the RIS elements in the RIS portion 734 are the phase value of the RIS portion 732+ϕₘ in Slot 1, the phase value of the RIS portion 732+ϕₘ+0.5π in Slot 2, the phase value of the RIS portion 732+ϕₘ+π in Slot 3, and the phase value of the RIS portion 732+ϕₘ+1.5 in Slot 4. However, it should be noted that the phase value for redirecting the signal to the destination, also referred to as the first phase value herein, may also be included, but is not shown explicitly in the equations of FIG. 7B. More detailed examples are provided below or elsewhere in the present disclosure.

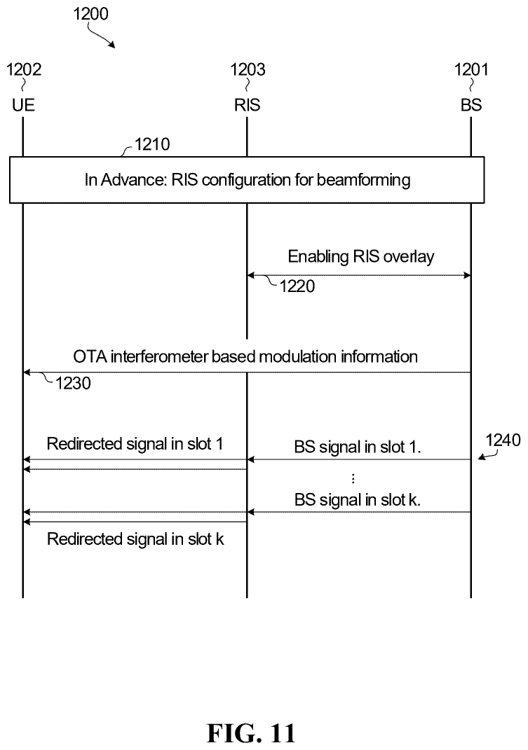

In FIG. 7B, it is illustrated that the further phase values {0, 0.51, 1, 1.5} are added to the RIS portion 734, the RIS portion to which ϕₘ is added, Slot 1, Slot 2, Slot 3 and Slot 4, respectively. However, it should be noted that the phases {0, 0.51, 1, 1.51} may be added to other RIS portion(s) (e.g., RIS portion 732 in FIG. 7B or RIS portion 1136 in FIG. 11). It should be also noted that the further phase values {0, 0.5π, π, 1.5π} may be added to the RIS portion 734 or other RIS portion(s) in a different order over each of the time slots (e.g., 0.5π, π, 1.5π, 0 are added in Slot 1, Slot 2, Slot 3, and Slot 4, respectively). When four time slots are being used, as described in the examples above, it should be understood that phase values other than {0, 0.5π, π, 1.5π} may be added to the RIS portion 734 over the four time slots. More generally, the values of the phase shifts used for the corresponding number of time slots, which may be different than four time slots, may be selected appropriately to enable the OTA interferometer to modulate ϕₘ on the signal being redirected by the RIS. It should be further noted that there can be more or less than 4 further phase values. For example, if further phase values comprise {0, 0.25π, 0.5π, 0.75π, 1π, 1.25π, 1.5π, 1.75π}, each of the further phase values would be added to the RIS portion 734 or other RIS portion(s) over 8 time slots. Note that for each setting of different phase allocation, the estimation of the data dependent phase (ϕₘ) can be changed considering the strengths of the received signals in different time slots.

After the phase values are determined for the respective elements of the RIS portions, the phase value are applied to the elements during the appropriate time slots. Subsequent to the signal from the base station 710 being redirected at the RIS 730, the UE 720 may be capable of measuring the strength of the signals received from the RIS 730 in each time slot with a simple receiver. Based upon the signal strength measurements, the phase value ϕₘ that has been added to at least one RIS portion may be determined based on the relationships in Equation (3) presented below:

$$tan {ϕ}_{m} = \frac{{ρ}_{4} - {ρ}_{2}}{{ρ}_{1} - {ρ}_{3}} \qquad ( 3 )$$

$${ρ}_{1} - {ρ}_{3} = 4 \sqrt{{P}_{r 1} {P}_{r 2}} cos {ϕ}_{m}$$

$${ρ}_{4} - {ρ}_{2} = 4 \sqrt{{P}_{r 1} {P}_{r 2}} sin {ϕ}_{m}$$

where ρₖ for ke {1,2,3,4} is the strength of the received signal in slot k, Pᵣ₁ is the strength of the signal received from the RIS portion 732, and Pᵣ₂ is the strength of the signal received from the RIS portion 734, as shown in FIGS. 7A and/or 7B. Examples of the signal strength include one or more of SNR, reference signal received power (RSRP), and received signal strength indicator (RSSI).

Therefore, in short, the RIS 730 applies a phase component in the RIS elements according to Equation (1), for example to redirect the signal and add PSK phase ϕₘ in the RIS portion 734. Then, the UE 720 may receive the signals and using the relationships illustrated above in Equation (3) and the measurements made during the plurality of time slots determine phase ϕₘ. It is noted that, in the relationships in Equation (3), (ρ₁-ρ₃) may virtually correspond to an in-phase (I) component of a signal and (ρ₄-ρ₂) may virtually correspond to the quadrature (Q) component of a signal. These virtually corresponding relationships may be used to represent I and Q components of a data signal that is being modulated on a redirected signal, for example using MPSK or QAM modulation.

It is further noted that if the RIS basic configuration to redirect the signal from the base station 710 to the UE 720 is inaccurate (e.g., inaccurate θ_{AoD} or θ_{AoA} in Equation (1)), but the signal is still redirected to the UE 720 with sufficient power, the base station 710 may still send a pilot or a reference signal (RS) and the interferometer method may be applied first without adding a new phase (e.g., adding only the third phase value (e.g., {0, 0.5π, π, 1.5π} over 4 time slots)) or with adding a known phase (e.g., adding a known value for the second phase component and the third phase value (e.g., {0, 0.5π, π, 1.5π} over 4 time slots)). Then, the UE 720 may estimate the phase difference (ϕ′) between the signals redirected from the RIS portions 732 and 734 and received by the UE 720 following a similar approach pertaining to Equation (3). After the phase difference (ϕ′) estimation, the OTA-interferometer based modulation may be applied and the UE may compensate for the phase difference value based on the estimated phase difference. For example, when applying the modulation, which may be MPSK or QAM, the phase value ϕₘ that has been added to at least one RIS portion may be determined based on the signal strength measurements and the relationships satisfying Equation (2′) presented below:

$$tan ( {ϕ}_{m} + {ϕ}^{′} ) = \frac{{ρ}_{4} - {ρ}_{2}}{{ρ}_{1} - {ρ}_{3}} \qquad ( 2 )$$

$${ρ}_{1} - {ρ}_{3} = 4 \sqrt{{P}_{r 1} {P}_{r 2}} cos ( {ϕ}_{m} + {ϕ}^{′} )$$

$${ρ}_{4} - {ρ}_{2} = 4 \sqrt{{P}_{r 1} {P}_{r 2}} sin ( {ϕ}_{m} + {ϕ}^{′} )$$

Therefore, the UE 720 may compensate the phase (ϕ′) that was estimated using the RS and interferometer method before applying phase ϕₘ to send data. It is noted that after estimating the phase difference (ϕ′), the RIS configuration may be updated in a similar manner that the added phase value in the modulated signal (e.g., ϕₘ) is estimated using Equation (3).

The OTA-interferometer based modulation is performed by dividing the RIS into two or more RIS portions, in which each RIS portion redirects a signal transmitted by the source (e.g., base station) to the destination (e.g., UE), which receives the two or more signals from the respective RIS portions. The second phase value ϕₘ corresponds to the phase component added to at least one of the two or more RIS portions that is based on the data that the RIS is to modulate on the redirected signal.

In some embodiments, phase components are applied to the RIS portions over each of multiple time slots to implement the interferometric effect that enables the OTA-interferometer based modulation. Each phase component includes one or more phase values. In each RIS portion, the underlying phase value is applied to redirect the signal from the source (e.g., base station) to the destination (e.g., UE). As stated above, the first phase value can be obtained according to Equation (1) provided above. In at least one of the RIS portions (e.g., RIS portion 734), a second phase value related to the data from the input connected to the RIS is added. The data from the input connected to the RIS will be used to modulate the signal impinging the RIS 730 over the multiple time slots. Given that the second phase value is related to the data from the input connected to the RIS, the second phase value is considered to be data-dependent phase value. This data-dependent phase value can be indicated as ϕₘ, and the value is the same over the multiple time slots (e.g., all four time slots in the case illustrated in FIG. 7B). In addition, for the one of the RIS portions (e.g., RIS portion 734) that the second phase value is added, or at least one other RIS portion, the third phase values, which are different from one another over the plurality of time slots, can be added. The third phase values are {0, 0.5π, π, 1.5π} in the case illustrated in FIG. 7B. The third phase values are independent from the data obtained from the input connected to the RIS, and are therefore considered to be data-independent phase values. In each time slot, a data-independent phase value is applied to at least one of the RIS portions. As indicated above, the data-dependent phase value and the data-independent phase value may be added to the same RIS portion or different RIS portions. As such, the data-independent phase values are variable and therefore the overall phase value is different in each time slot. It should be noted that the data-independent phase values are related to interference patterns that may help extract the data-dependent phase value ϕₘ at the destination.

In some embodiments, the transmissions over the multiple time slots (e.g., 4 time slots in FIG. 7B) help estimation of the phase value related to the data from the input connected to the RIS (e.g., ϕₘ). The phase value of ϕₘ can be estimated via signal strength measurement. For example, a destination device (e.g., UE) receives the RIS redirected signals and may be used to estimate the value of ϕₘ by measuring signal strength of the received RIS redirected signal at each of the multiple time slots and using the relationships identified in Equation (3).

An example utilizing the OTA-interferometer based modulation is provided below with reference to FIGS. 7C and 7D.

FIG. 7C is an example of 8-PSK constellation diagram. The 8-PSK constellation diagram includes a set of eight constellation points (one identified as 701) that each represent a symbol that may correspond to data from the input (e.g., sensor) operatively connected to the RIS that can be modulated in the signal transmitted by the base station and redirected by the RIS.

The phase shifts for each RIS element in each time slot (i.e. Slot 1, Slot 2, Slot 3, Slot 4) can be determined as provided in FIG. 7D. FIG. 7D illustrates an example of phase values applied to elements of the RIS 730 in each of the four time slots, in accordance with embodiments of the present disclosure. Is this example, it is assumed that the RIS 730 is virtually divided into two RIS portions 732 and 734, and each RIS portion includes three RIS elements. Specifically, the RIS portion 732 includes RIS elements 732a, 732b and 732c, and the RIS portion 734 includes RIS elements 734a, 734b and 734c. As such, the RIS 730 includes six RIS elements in total. As illustrated below and FIG. 7D, each of the six RIS elements 732a, 732b, 732c, 734a, 734b and 734c has a respective phase component (or phase value) applied thereto that is different than the phase component or phase value applied to adjacent RIS elements.

In this example, based on Equation (1) provided above, the phase difference between two consecutive RIS elements is determined to be 10 degrees. It should be noted that the AoA and AoD at the RIS 730 can be measured using various methods such as beam sweeping.

Specifically, in Slot 1, the phase difference between adjacent RIS elements is 10 degrees, and each of the RIS elements 732a, 732b and 732c has a first phase value of 10 degrees, 20 degrees and 30 degrees, respectively. However, the phases of the elements 734a, 734b and 734c of the other RIS portion 734 are different from the phases of the RIS elements 732a, 732b and 732c. The phases of the elements 734a, 734b and 734c are increased by a second phase value ϕₘ in addition to the 10 degree phase difference between the adjacent RIS elements as in RIS portion 732, and therefore phases of the elements 734a, 734b and 734c become 62.5 degrees (40 degrees+ϕₘ), 72.5 degrees (50 degrees+ϕₘ) and 82.5 degrees (60 degrees+ϕₘ), respectively, where ϕₘ=22.5 degrees, as shown in FIG. 7D.

In Slot 2, each of the RIS elements 732a, 732b and 732c has the first phase value of 10 degrees, 20 degrees and 30 degrees, respectively, as in Slot 1. However, the phases of the elements 734a, 734b and 734c of the other RIS portion 734 are increased by the second phase value ϕₘ and further increased by a third phase value 90 degrees (i.e., 0.51). Therefore, the combined phase component of the elements 734a, 734b and 734c are 152.5 degrees (40 degrees+ϕₘ+0.5π), 162.5 degrees (50 degrees+ϕₘ+0.5π) and 172.5 degrees (60 degrees+ϕₘ+0.5π) in Slot 2, respectively, where Øm=22.5 degrees, as shown in FIG. 7D.

In Slot 3, each of the RIS elements 732a, 732b and 732c has the first phase of 10 degrees, 20 degrees and 30 degrees, respectively, as in Slot 1 and Slot 2. However, the phases of the elements 734a, 734b and 734c of the other RIS portion 734 are increased by the second phase value ϕₘ and further increased by the third phase value 180 degrees (i.e., 1π). Therefore, the combined phase component of the elements 734a, 734b and 734c are 242.5 degrees (40 degrees+ϕₘ+T), 252.5 degrees (50 degrees+ϕₘ+T) and 262.5 degrees (60 degrees+¢m+π) in Slot 3, respectively, where Øm=22.5 degrees, as shown in FIG. 7D.

In Slot 4, each of the first phase values of the RIS elements 732a, 732b and 732c remain the same, i.e. 10 degrees, 20 degrees and 30 degrees, as in Slot 1, Slot 2 and Slot 3. However, the phases of the elements 734a, 734b and 734c of the other RIS portion 734 are increased by the second phase value ϕₘ and further increased by the third phase value 270 degrees (i.e., 1.51). Therefore the combined phase component of the elements 734a, 734b and 734c are 332.5 degrees (40 degrees+ϕₘ+1.5π), 342.5 degrees (50 degrees+ϕₘ+1.5T) and 352.5 degrees (60 degrees++m+1.5π) in Slot 4, respectively, where ϕₘ=22.5 degrees, as shown in FIG. 7D.

The order of the additional phase component in the four time slots in the example of FIG. 7D is shown to increase from ϕₘ in Slot 1 to ϕₘ+0.5π in Slot 2 to ϕₘ+It in Slot 3 to ¢m+1.5π in Slot 4, which is the combination of the second and third phase values, and the phase is being changed in the RIS portion 734 of the RIS 730 but not at all in the RIS portion 732 of the RIS 730. However, it is to be understood that the phase component that is added in the various time slots and the particular RIS portions to which additional phase is being added may be different than shown in FIG. 7D. For example, the phase component that is added in the various slots and/or the particular RIS portion for which the phase is modified may be alternated, provided that the received signals in the different slots can be appropriately utilized at the UE to estimate the phase difference between the signals redirected by the RIS 730. Therefore, the UE may be provided configuration information by the base station that identifies which RIS portion is being modified in a given slot, in addition to configuration information that identifies the relative size of the portions of the RIS 730.

The example of FIG. 7D illustrates the RIS 730 being virtually divided into two parts, where the signal is transmitted over 4 time slots (i.e. Slot 1, Slot 2, Slot 3, Slot 4) and 4 different phase values (i.e., ϕₘ, ϕₘ+0.5π, ϕₘ+π, ϕₘ+1.5π) are added to only one of the RIS portions (i.e. RIS portion 734). As shown in FIG. 7D, each of the RIS portions 732 and 734 comprises a plurality of RIS elements and each RIS elements has a respective phase value that is different than adjacent RIS elements. It should be understood that alternative configurations may be used having different RIS virtual divisions (e.g., different number of RIS portions) and a different number of time slots (e.g., 8 time slots) with different added phases (e.g., phase values added in order of {π, 1.5π, 0.5π, 0}) than with regard to what is shown in FIG. 7D.

Furthermore, while the phase component is described as being modified, it may be considered that a single phase component is determined for each RIS portion that is based on one or more of the first phase value used to redirect a signal at the RIS, the second phase value used to modulate the signal at the RIS (also referred to as data dependent phase value) and the third phase value used to implement the OTA-interferometer based modulation (also referred to as the data independent phase value).

As illustrated above, the OTA-interferometer based modulation techniques may be used to modulate phases of signals originally transmitted by the base station and redirected by the RIS. In some embodiments, the OTA-interferometer based modulation techniques may also be used to control or modulate amplitudes of the signals using, for example, quadrature amplitude modulation (QAM) modulation.

Equation (3), which is derived from the 6-port OTA interferometer, is again provided below to illustrate the OTA-interferometer based modulation techniques used for modulating amplitude of the signals to be redirected by the RIS in addition to determining phase difference between signals as described above.

$${ρ}_{1} - {ρ}_{3} = 4 \sqrt{{P}_{r 1} {P}_{r 2}} cos {ϕ}_{m} , \qquad ( 3 )$$

$${ρ}_{4} - {ρ}_{2} = 4 \sqrt{{P}_{r 1} {P}_{r 2}} sin {ϕ}_{m} ,$$

where ρₖ for ke {1,2,3,4} is the strength of the received signal in slot k. Provided that there are two RIS portions (e.g., RIS portion 732 and RIS portion 734), Pr₁ is the strength of the signal redirected by the first RIS portion (e.g., RIS portion 732), and Pᵣ₂ is the strength of the signal redirected by the second RIS portion (e.g., RIS portion 734).

The strength of the signals depends on the size of the RIS portion. Put another way, Pᵣ₁ and Pᵣ₂ are determined based upon the size of the corresponding RIS portion. Specifically, Pᵣ₁ is determined based upon the relative proportion of the first RIS portion (e.g., RIS portion 732) and Pᵣ₂ is determined based upon the relative proportion of the second RIS portion (e.g., RIS portion 734), as illustrated below in Equation (4):

$${P}_{r 1} ∝ {( α {A}_{RIS 1} )}^{2} = {A}_{RIS 1}^{2} \qquad ( 4 )$$

$${P}_{r 2} ∝ {( ( 1 - α ) {A}_{RIS 2} )}^{2} = {A}_{RIS 2}^{2}$$

where A_{RIS1} is the size of the first RIS portion (e.g., RIS portion 732), A_{RIS2} is the size of the second RIS portion (e.g., RIS portion 734), α is the relative proportion of first RIS portion (e.g., RIS portion 732), and 1-α is the relative proportion of the second RIS portion (e.g., RIS portion 734).

Equations (3) and (4) indicate that the amplitudes of ρ₁−ρ₃ and ρ₄−ρ₂ are determined based upon the multiplication α×(1−α). Therefore, a maximum value is achieved when α=1−α=0.5, which is when the RIS portions are equal in size.

In some embodiments, the phase modulation may be controlled by adjusting the phase difference ϕₘ between signals redirected by two consecutive RIS portions, and the amplitude modulation may be controlled by adjusting the proportion (relative size) of each RIS portion (i.e. changing a).

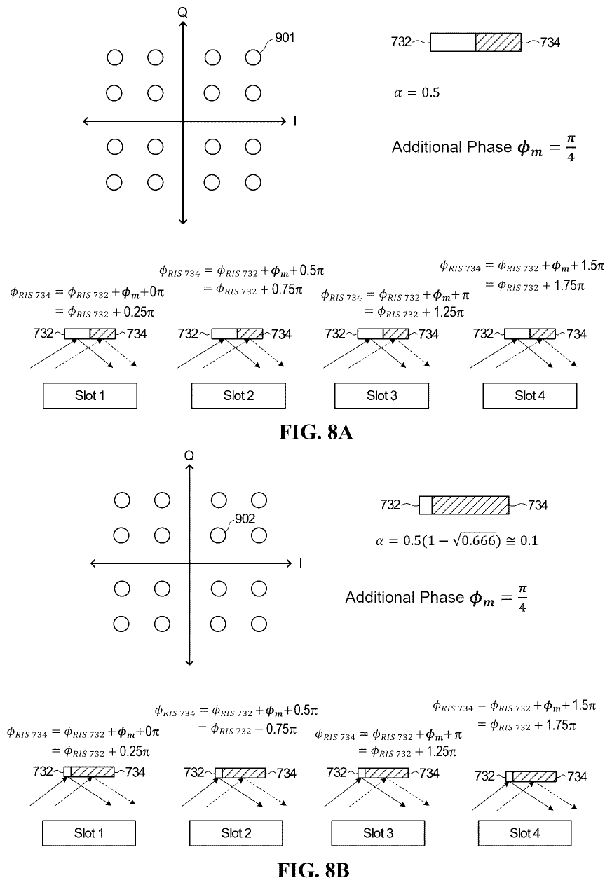

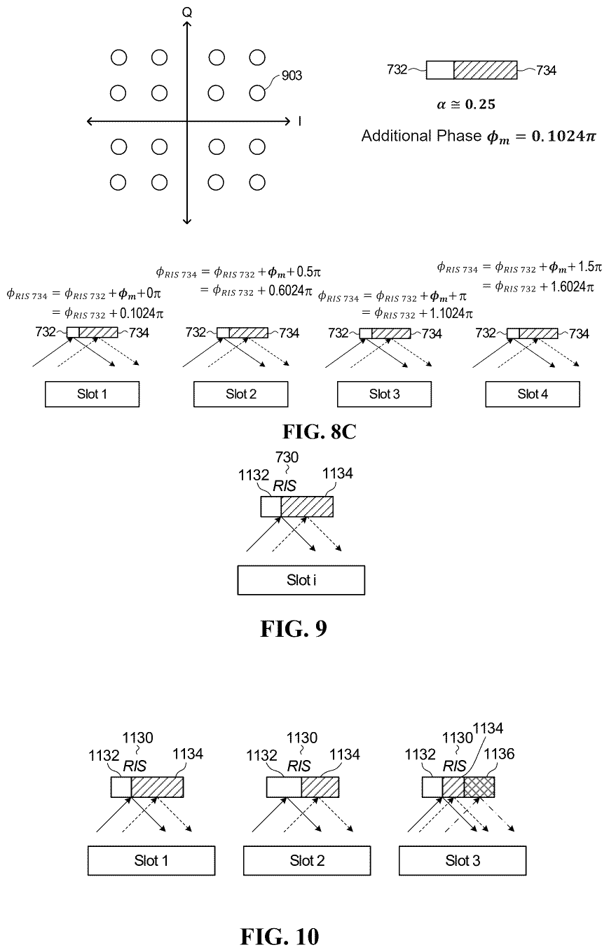

Therefore, QAM modulation may be implemented by adjusting both ϕₘ and α, as illustrated in the examples of FIGS. 8A to 8C. FIGS. 8A to 8C illustrate an example of a 16-QAM constellation diagram, how three particular constellation points may be implemented, i.e. the phase and amplitude, based on controlling the phase and proportion of the RIS portions in accordance with embodiments of the present disclosure. The constellation points 901, 902 and 903 shown in FIGS. 8A to 8C can be obtained based on the values of ϕₘ, and a shown in Table 1 below. The other constellation points in the 16-QAM constellation can be similarly obtained based on values of ϕₘ and a.

TABLE 1

| Symbol | | | |
|---|---|---|---|
| (constellation | | | |
| point) | RIS part 1 portion (α) | Added phase (ϕₘ) | |
| 901 | 0.5 | 45° | (π/4) |
| 902 | 0.5(1 − \sqrt{0.666}) ≅ 0.1 | 45° | (π/4) |
| 903 | ≅0.25 | 18.4° | (0.1024π) |

For the constellation point 901 in FIG. 8A, the amplitude of the constellation point 901 is related to the value of a (relative size of the RIS portion 732 with respect to the overall size of RIS 730 over 4 time slots). The phase of the constellation point 901 is related to the data-dependent phase value ϕₘ of the phase component applied to the RIS portion 734. As shown in Table 1, in the case of the constellation point 901, the value of α is 0.5 and the data-dependent phase value (ϕₘ) added to the RIS portion 734 over 4 time slots is ¼. Therefore, the RIS 730 is equally divided into two RIS portions, RIS portion 732 and RIS portion 734, as illustrated in FIG. 8A. Also, provided that the value of ϕₘ is π/4, the further phases added to the RIS portion 734 in each of Slot 1, Slot 2, Slot 3 and Slot 4, respectively, would be 0.25π, 0.75π, 1.25π and 1.75π (i.e., ϕm, ϕₘ, +0.5π, ϕₘ+π, ϕₘ+1.5π), which is the sum of ϕₘ and the data-independent variable phase value (i.e. one of {0, 0.5π, π, 1.5π}). Therefore, four different phase values applied to in the RIS portion 734 over the 4 time slots are the phase value of the RIS portion 732 including the first phase value for redirecting the signal to the destination device (e.g., UE) and 0.25π, 0.75π, 1.25π, and 1.75π in Slot 1, Slot 2, Slot 3, and Slot 4, respectively. It is noted that although the addition of the first phase value for redirecting the signal to the destination device (e.g., UE) is not shown in the formulas in FIG. 8A, a person skilled in the art would readily understand that the first phase value is already added in the same or similar way explained above and FIG. 7D or elsewhere in the present disclosure. For example, a particular implementation where the RIS 730 of FIG. 8A consists of 20 linearly arranged RIS elements where the first phase value between two consecutive elements for redirecting the signal to the destination device is equal to 10 degrees. Then, RIS portion 732 consists of the first ten RIS elements (i.e., the first to tenth RIS elements) while RIS portion 734 consists of the last ten RIS elements (i.e., the eleventh to twentieth RIS elements). In such cases, the phases of the first, second, . . . , and tenth RIS elements may be 10 degrees, 20 degrees, . . . , and 100 degrees, respectively, in each of the 4 time slots. Provided that ϕₘ is ¼, the phase values of the eleventh to twentieth RIS elements included in the RIS portion 734, in Slot 1, are 155 degrees (110 degrees+ϕₘ), 165 degrees (120 degrees+ϕₘ), . . . , and 245 degrees (200 degrees+ϕₘ), respectively. Similarly, in Slot 2, the phase values of the eleventh to twentieth RIS elements included in the RIS portion 734, are 245 degrees (110 degrees+ϕₘ+0.5π), 255 degrees (120 degrees+ϕₘ+0.5π), . . . , and 335 degrees (200 degrees+ϕₘ+0.5π), respectively. The phase values of the eleventh to twentieth RIS elements included in the RIS portion 734 in Slot 3 and Slot 4 may be obtained in the same or similar manner explained above or elsewhere in the present disclosure.

For the constellation point 902 in FIG. 8B, the amplitude of the constellation point 902 is also related to the value of a (relative size of the RIS portion 732 with respect to the overall size of RIS 730 over 4 time slots). The phase of the constellation point 902 is again related to the data-dependent phase value ϕₘ of the phase component applied to the RIS portion 734. As shown in Table 1, in the case of the constellation point 902, the value of α is approximately 0.1 (=0.1) and the data-dependent phase value (ϕₘ) added to the RIS portion 734 over 4 time slots is ¼. Therefore, the RIS 730 is unequally divided into two RIS portions 732 and 734, as illustrated in FIG. 8B. Also, provided that the value of ϕₘ is π/4, the additional phases added to the RIS portion 734 in each of Slot 1, Slot 2, Slot 3 and Slot 4, respectively, would be 0.25π, 0.75π, 1.25π and 1.75π (i.e., ϕm, ϕₘ+0.5π, ϕₘ+π, ϕₘ+1.5π), which is the sum of ϕₘ and the data-independent variable phase value (i.e. one of {0, 0.5π, π, 1.5}) . . . . Therefore, the 4 different phase values applied to in the RIS portion 734 over 4 time slots are the phase value of the RIS portion 732 including the first phase value for redirecting the signal to the destination device (e.g., UE) and 0.25π, 0.75π, 1.25π, and 1.75π in Slot 1, Slot 2, Slot 3, and Slot 4, respectively. It is noted that although the addition of the first phase value for redirecting the signal to the destination device (e.g., UE) is not shown in the formulas in FIG. 8B, a person skilled in the art would readily understand that the first phase value is already added in the same or similar way explained above and FIG. 7D or elsewhere in the present disclosure. For example, a particular implementation where the RIS 730 of FIG. 8B consists of 20 linearly arranged RIS elements where the first phase value between two consecutive elements for redirecting the signal to the destination device is equal to 10 degrees. Then, RIS portion 732 consists of the first two RIS elements while RIS portion 734 consists of the last eighteen RIS elements. In Slot 2, the phases of the 1st and 2nd RIS elements can be 10 degrees, and 20 degrees, respectively, while the phases of the 3rd, 4th, . . . , and 20th, RIS elements can be 165 degrees, 175 degrees, . . . , and 335 degrees, respectively. The phase values of the RIS elements included in other slots may be obtained in the same or similar manner explained above or elsewhere in the present disclosure. One example is provided above in association with FIG. 8A

For the constellation point 903 in FIG. 8C, the amplitude of the constellation point 903 is also related to the value of a (relative size of the RIS portion 732 with respect to the overall size of RIS 730 over 4 time slots). The phase of the constellation point 902 is again related to the data-dependent phase value ϕₘ of the phase component applied to the RIS portion 734. As shown in Table 1, in the case of the constellation point 902, the value of α is approximately 0.25 (˜ 0.25) and the data-dependent phase value (ϕₘ) added to the RIS portion 734 over 4 time slots is 0.1024π. Therefore, the RIS 730 is unequally divided into two RIS portions 732 and 734, as illustrated in FIG. 8C. Also, provided that the value of ϕₘ is π/4, the additional phases added to the RIS portion 734 in each of Slot 1, Slot 2, Slot 3 and Slot 4, respectively, would be 0.1024π, 0.6024π, 1.1024π, and 1.6024π (i.e., ϕₘ, ϕₘ+0.5π, ϕₘ+π, ϕₘ+1.5π), which is the sum of ϕₘ and the data-independent variable phase value (i.e. one of {0, 0.5π, π, 1.5π}). Therefore, the 4 different phase values applied to in the RIS portion 734 over 4 time slots are the phase value of the RIS portion 732 including the first phase value for redirecting the signal to the destination device (e.g., UE) and 0.1024π, 0.6024π, 1.1024π, and 1.6024π in Slot 1, Slot 2, Slot 3, and Slot 4, respectively. It is noted that although the addition of the first phase value for redirecting the signal to the destination device (e.g., UE) is not shown in the formulas in FIG. 8C, a person skilled in the art would readily understand that the first phase value is already added in the same or similar way explained above and FIG. 7D or elsewhere in the present disclosure. For example, a particular implementation where the RIS 730 of FIG. 8C consists of 20 linearly arranged RIS elements where the first phase value between two consecutive elements for redirecting the signal to the destination device is equal to 10 degrees. Then, RIS portion 732 consists of the first five RIS elements while RIS portion 734 consists of the last fifteen RIS elements. In Slot 2, the phases of the 1st, 2nd, . . . , and 5th RIS elements can be 10 degrees, 20 degrees, . . . , and 50 degrees, respectively, while the phases of the 6th, 7th, . . . , and 20th, RIS elements can be 168.4 degrees, 178.4 degrees, . . . , and 308.4 degrees, respectively. The phase values of the RIS elements included in other slots may be obtained in the same or similar manner explained above or elsewhere in the present disclosure. One example is provided above in association with FIG. 8A.

As illustrated above, the OTA-interferometer based modulation techniques may be used for MPSK and QAM modulations. In some embodiments, the OTA-interferometer based modulation technique may be utilized for encoding data, such as information provided to the RIS (e.g., from a sensor operatively connected to the RIS).

In some embodiments, the RIS is divided into a plurality of RIS portions, each of which may have same or different size. Also, different phase components, that may be a combination of one or more of the first, second and third phase values may be applied to the different RIS portions. In various embodiments, the different phase components applied to the different RIS portions and different relative sizes of different RIS portions may result in different interference patterns of signals redirected from each of the RIS portions. Such interference patterns may be used to encode data, for example information provided to the RIS via an input (e.g., sensor) operatively connected to the RIS.

FIG. 9 illustrates, in a schematic diagram, an example time slot transmission with two unequally divided RIS portions, in accordance with embodiments of the present disclosure. The RIS 730 is divided into two RIS portions 732 and 734. The RIS portion 732 and the RIS portion 734 have different sizes, due to unequal division. Phase (μ) is added to the RIS portion 734 and the value of this added phase (μ) may be chosen in the range of 0 to 2π. The relative size of each RIS portion (i.e. ratio α) and the phase shift values added to each RIS portion may vary widely in each time slots, as stated above.

While the RIS may be divided into two RIS portions as shown in FIG. 9, the RIS may be divided into more than two RIS portions as illustrated in FIG. 10. FIG. 10 illustrates, in a schematic diagram, an example with three time slot transmission using variously divided RIS portions, in accordance with embodiments of the present disclosure. Referring to FIG. 10, the RIS 1130 is divided into two RIS portions 1132 and 1134 at Slot 1, that have different sizes. A phase value of RIS portion 1132 in Slot 1 is based on a first phase value for redirecting the signal from the base station to the UE. A phase value (μ₁) is added to the RIS portion 1134 in Slot 1 in addition to the first phase value. The phase value (μ₁) that may include one or both of the second and third phase values is added to the RIS portion 1134 in Slot 1 and the value of this added phase (μ₁) may be chosen in the range of 0 to 21. Thus, the phase value of the RIS portion 1134 in Slot 1 is the phase value of the RIS portion 1132 in Slot 1 plus the value of the added phase μ₁.

At Slot 2, the RIS 1130 is equally divided into two RIS portions 1132 and 1134, and due to the equal division, the two RIS portions 1132 and 1134 have same sizes. A phase value of RIS portion 1132 in Slot 2 is based on a first phase value for redirecting the signal from the base station to the UE. Another phase value (μ₂) that may include one or both of the second and third phase values is added to the RIS portion 1134 in Slot 2 and the value of this added phase (μ₂) may be also chosen in the range of 0 to 2π. Thus, the phase value of the RIS portion 1134 in Slot 2 is the phase value of the RIS portion 1132 in Slot 2 plus the value of the added phase μ₂.

At Slot 3, the RIS 1130 is unequally divided into three RIS portions 1132, 1134 and 1136, and due to the unequal division, these three RIS portions 1132, 1134 and 1136 have different sizes. A phase value of RIS portion 1132 in Slot 3 is based on a first phase value for redirecting the signal from the base station to the UE. Two different phase values are added to the RIS portions 1134 and 1136, respectively in Slot 3. The phase value (31 that may include one or both of the second and third phase values is added to the RIS portion 1134 in Slot 3 and the value of this added phase (μ₃₁) can be chosen in the range of 0 to 21. Similarly, the phase value μ₃₂ that may include one or both of the second and third phase values is added to the RIS portion 1136 in Slot 3 and the value of this added phase (μ₃₂) can be also chosen in the range of 0 to 21. Thus, provided the phase value of each RIS portion is determined in relation to the phase value of the adjacent (previous) RIS portion, the phase value of the RIS portion 1134 in Slot 3 is the phase value of the RIS portion 1132 in Slot 3 plus the value of the added phase μ₃₁, and the phase value of the RIS portion 1136 in Slot 3 is the phase value of the RIS portion 1134 in Slot 3 plus the value of the added phase μ₃₂. In some embodiments, the phases added into each of the RIS portions in each time slot are the phase values added to the phase value for redirecting a signal to the destination, as provided in Equation (1). As stated above, the added phase can be independently determined for each RIS portion and in each Slot, in the range of 0 to 21.

Provided that various phases added into each of a plurality of RIS portions can result in various interference patterns as illustrated in FIG. 10, the information (e.g., data provided to the RIS via an input operatively connected to the RIS) may be encoded as a sequence of multiple time slot transmission using various interference patterns created by the multiple signals being redirected by the RIS and received at the UE. In some embodiments, the base station or a network side device may transmit configuration information to the UE that includes decoding rules for decoding the encoded information. At the destination or receiver, the combined amplitudes measured in each sequence of the multiple time slot transmission may be used to recover the information modulated on the signal from the base station by the RIS.

It should be noted that the transmitter and the receiver, for proper communication, exchange information that defines the coding scheme of the multiple time slot transmission and the mapping of different amplitude sequences to the data being modulated on the signal by the RIS

The following provides an example of signaling associated with using the OTA-interferometer based modulation with reference to FIG. 11.

FIG. 11 is a signal flow diagram 1200 that illustrates signaling between a base station (BS) 1201, a UE 1202 and a RIS 1203 that enables operation of the three devices as an OTA interferometer capable of OTA-interferometer based modulation in accordance with embodiments of the present disclosure.

The base station 1201, an access point (not shown in FIG. 11), or the network that the base station 1201 or the access point is a part of, may determine an angle of departure (AoD) of a signal from the base station 1201 and/or an angle of arrival (AoA) at the RIS 1203. Such information may be obtained by using sensing information that provides the UE location (with some ambiguity) oπ by using wide-beam sweeping measurements between the base station 1201, RIS 1203 and UE 1202. This process may be a part of step 1210.

At step 1210, when the base station 1201, or the network of which the base station 1201 is a part, know the locations of the base station 1201 and RIS 1203, the base station 1201 may beamform a signal in the direction of the RIS 1203. The signal includes configuration information for the RIS 1203 via radio resource control (RRC) signaling to redirect reference signals (RSs) in different directions (i.e. different AoDs from the RIS 1203) in a general direction towards the destination UE (e.g., general direction to the UE 620 in FIG. 6). The configuration information may include information such as an angle of arrival (AoA) at the RIS of one or more beams on which the reference signal is transmitted, an assumed angle of departure (AoD) at the RIS for the beams that include the reference signal being redirected, and frequency information about the reference signal. An example of a type of reference signal may be channel state information reference signals (CSI-RS).

Still at step 1210, the base station 1201 may send configuration information to the UE 1202 to notify the UE 1202 about the reference signal that is used in the beam sweeping process. The configuration information received by the UE 1202 may include one or more of: the type of reference signal being transmitted by the base station 1201, information used to identify the reference signal, information about the type of measurements the UE 1202 should make and what type of information should be fed back to the base station 1201.

The base station 1201 may then send the reference signals that will be redirected in different directions by the RIS 1203 based on the configuration information the RIS 1203 received earlier. The UE 1202, while performing beam sweeping, performs measurements of the received reference signals (RS) based on the configuration sent to the UE 1202 by the base station 1201. Examples of the types of measurements made by the UE 1202 may include one or more of the signal strength, reference signal received power (RSRP), signal-to-noise (SNR), and received signal strength indicator (RSSI).

Still at step 1210, the UE 1202 generates feedback information that identifies one or more reference signal with measurements that meet a threshold (e.g., signal strength is greater or equal a specific value). The UE 1202 transmits the generated feedback information to the base station 1201. The information that identifies one or more reference signal may use a reference signal index value assigned to the reference signal beams to identify respective beams.

Still at step 1210, from the measurements received from the UE 1202, the base station 1201 determines a coarse AoD estimation. Based on the coarse AoD estimate, the base station 1201 may determine the phase difference between adjacent RIS elements to allow the RIS 1203 to redirect a signal to the UE 1202. The base station 1201 can then determine a preferred beam to send the RS to be used for the OTA interferometer. The beam may be associated with a particular index value used to identify the beam.

At step 1220, the network of which the base station 1201 is a part enables modulation by the RIS of a data signal on a signal transmitted by the base station 1203 and redirected in the direction of the UE 1202, for example through auxiliary channel. The input (e.g., sensor) operatively connected to the RIS 1203 provides the data signal. The network enables such data signal transmissions where the base station 1201 sends a signal that can be modulated by the RIS 1203 for example based on the data signal and parameters such as, but not limited to, phase information at one or more RIS elements in each of the plurality of RIS portions that is used to redirect the signal from the source to the destination; the number of the plurality of the RIS portions; the number of time slots used for the data transmission to enable the OTA-interferometer based modulation; information related to signals that impinge the RIS at each of the plurality of time slots (e.g., type of pilots or reference signals); phase shift information for use in modifying phase values of at least one of the plurality of RIS portions with respect to at least one other of the plurality of RIS portions in each of the plurality of time slots (e.g., data-dependent phase value (ϕₘ) added to the RIS portion 734 and additional data-independent variable phase values {0, 0.5π, π, 1.5π} applied to the RIS portion 734 over four time slots); a relative size of each of the plurality of RIS portions; and a type of modulation scheme. The phase shift information for use in modifying phase values of at least one of the plurality of RIS portions with respect to at least one other of the plurality of RIS portions in each of the plurality of time slots may comprise two parts. The first part may be the data-dependent phase value (ϕₘ) added to at least one of the plurality of RIS portions. The second part may be additional data-independent variable phase values applied to the at least one RIS portion or at least one other RIS portion of the plurality of RIS portions over the plurality of time slots (e.g., phase values {0, 0.5π, π, 1.5π} to be applied over 4 time slots). The second part (i.e. additional data-independent variable phase values) is related to the pattern that may help extract the data phase. Using the configuration data and the data obtained from the input connected to the RIS 1203, the RIS determines, for each of the plurality of time slots, phase components to be applied to the plurality of RIS portions, wherein at least one of the phase components to be applied to at least one RIS portion comprises a first phase value for redirecting the signal from a transmitter to a receiver and a second phase value dependent on the data. A third phase value independent of the data that is different in each of the plurality of time slots may be added to one or more of the RIS portions.

At step 1230, the base station 1201 or the network of which the base station 1201 is a part, sends to the UE 1202 higher layer signaling (e.g., RRC) pertaining to configuration the OTA-interferometer based modulation. The OTA-interferometer based modulation configuration information transmitted from the base station 1201 to the UE 1202 includes one or more of the following types of information: an indication of whether or not the RIS is enabled for modulation of the signal from the base station 1201, i.e. whether the UE can expect an additional signal overlaid on the signal transmitted from the base station 1201; the number of plurality of the RIS portions; the number of slots that may be used for the OTA-interferometer based modulation transmission (e.g., 4 slots in the 6-port interferometer described in the example of FIG. 7B); phase shift information for use in modifying phase values of at least one of the plurality of RIS portions with respect to at least one other of the plurality of RIS portions in each of the plurality of time slots (e.g., data-dependent phase value (ϕₘ) added to the RIS portion 734 and additional data-independent variable phase values {0, 0.5π, π, 1.5π} applied to the RIS portion 734 over four time slots); a type of modulation and/or demodulation scheme(s) that may be used by the RIS 1203; a decoding rule to be used by the UE 1202, e.g., the signal strength (e.g., SNR) combination that resembles the in-phase and quadrature components, the interference patterns associated with each set of time slot, i.e. four time slots, sequence and a mapping of the data being modulated by the RIS 1203; information (e.g., scheduling information such as a period) related to periodic transmission of pilot or reference signals for updating RIS configuration (e.g., estimated values for AoD and/or AoA) or interference patterns (e.g., pilot signatures) or updating phase compensation or decoding rule at the destination (e.g., UE). The phase shift information for use in modifying phase values of at least one of the plurality of RIS portions with respect to at least one other of the plurality of RIS portions in each of the plurality of time slots may comprise two parts. The first part may be the data-dependent phase value (ϕₘ) added to at least one of the plurality of RIS portions. The second part may be additional data-independent variable phase values applied to the at least one RIS portion or at least one other RIS portion of the plurality of RIS portions over the plurality of time slots (e.g., phase values {0, 0.51, 1, 1.51} to be applied over 4 time slots). The second part (i.e. additional data-independent variable phase values) is related to the pattern that may help extract the data phase. The periodic transmission of pilot or reference signals may be performed in consideration of one or more of angular changes (e.g., phase shifts) and interference patterns.

At step 1240, provided that the RIS 1203 is configured to redirect and modulate the signals from the base station 1201 (determined by the RIS based on the configuration information and data obtained from the input connected to the RIS 1203), the base station 1201 sends signals in each of multiple time slots that are redirected by the RIS 1203. The signals sent by the base station 1201 are modulated and redirected by the RIS 1203, as illustrated above and elsewhere in the present disclosure. The data received by the input operatively connected to the RIS 1203 using the modulated and redirected signals, sends the data to the UE 1202. Upon receiving the signals, the UE 1202 measures signal strength of the received signals at each of the multiple time slots. Then, the UE 1202 determines, based on the measured signal strengths of the received signals at each of the plurality of time slots, the phase value modulating the signals, for example using the relationships in Equation (3) above. The phase value modulating the signal of the plurality of signals is related to the data obtained from the input connected to the RIS 1203. Upon determining the phase value, the UE 1202 may send, to the RIS 1203, signal(s) that may include feedback information related to phase value measurements.

While various aspects of the OTA-interferometer based modulation technique are primarily illustrated for data transmissions where the RIS redirects a base station signal, various aspects of the OTA-interferometer based modulation technique illustrated in the present disclosure may be also similarly applied to various other data transmissions (e.g., UL communications, sidelink (SL) communications). For example, instead of the RIS, a transmitter with multiple antennas or multiple panels can send data from its antennas by applying the proposed OTA-interferometer based modulation where a subset of the antenna resembles one RIS portion while another subset resembles another RIS portion. In a particular example, a UE may have low power (or low power capacity) and has data to send to a destination node (e.g., base station, UE). The UE may be operatively connected to an RIS and, with help of a signal from another node, may be able to send its data to the destination using the OTA-interferometer based modulation technique illustrated in the present disclosure. The communication is considered to be uplink (UL) communication when the UE is sending the data to the base station, and the communication is considered to be sidelink (SL) communication when the UE is sending the data to the terminal UE.

For the UL communications, the UE may send a signal to a base station or another UE (terminal UE), a request for a source signal that can be modulated with lower power utilizing the RIS operatively connected to the UE. Upon receiving the request from the UE, the base station sends a signal to the terminal UE to transmit a source signal to the UE. The base station and UE share the same modulation scheme(s) via the RIS using the OTA-interferometer based modulation technique illustrated in the present disclosure. It should be noted that the UE may generate its own signal and use it as a source signal that impinges the RIS and can be modulated using the OTA-interferometer based modulation technique illustrated in the present disclosure.

For the SL communications, the UE may send, a signal to a base station or another UE (terminal UE), a request for a source signal that can be modulated with lower power utilizing the RIS operatively connected to the UE. The UE or the base station may inform the terminal UE about the modulation scheme(s) and decoding rule(s) for the modulation, via the RIS operatively connected to the UE using the OTA-interferometer based modulation technique illustrated in the present disclosure. It should be noted that the UE may generate its own signal and use it as a source signal that impinges the RIS and can be modulated using the OTA-interferometer based modulation technique illustrated in the present disclosure. An example for DL communication may be the scenario where a base station or an access point (AP) is connected to an RIS and has data to send to a UE by utilizing the RIS and a signal from another node as illustrated in the OTA-interferometer based modulation.

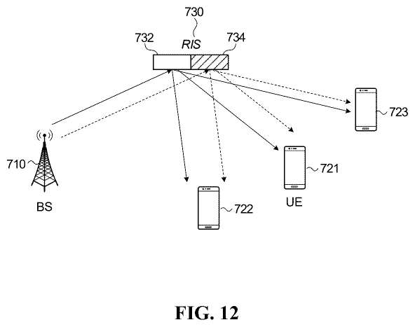

It should be understood that the proposed OTA-interferometer method may be extended to multiple UEs. FIG. 12 illustrates a portion of a wireless network similar to that shown in illustrated in FIG. 7A. There are a base station (BS) 710, a RIS 730 and there are multiple UEs 721, 722 and 723. The base station 710, or a network of which the base station 710 is a part, configures the RIS 730 such that the RIS 730 is virtually divided into two or more RIS parts (i.e., two or more RIS portions). The RIS 730 may be divided into equal parts, as shown in FIG. 12, or into non-equal parts. In FIG. 12, the RIS 730 is equally divided into only two RIS portions 732 and 734, where each RIS portion includes one or more RIS elements. As described above, a sensor operatively connected to the RIS has data to be sent to one or more of the multiple UEs 721, 722 and 723. In FIG. 12 the RIS 730 intends to send the same data to all of the multiple UEs 721, 722, and 723 in a broadcast fashion. In some embodiments, the data originating from the sensor (not shown in FIG. 12) operatively connected to the RIS 730 may be used to perform OTA-interferometer based modulation on a signal being sent to each of the UEs 721, 722, and 723, separately in different time resources. In some embodiments, a signal from the base station 710 is redirected by the RIS via wide-beam 730 to the multiple UEs 721, 722 and 723, upon which the data originating from the sensor connected to the RIS 730 may simultaneously be sent to all UEs 721, 722, and 723 using OTA-interferometer based modulation. As the RIS redirection may not be accurate for redirecting to all UEs 721, 722, and 723, the base station 710 sends a pilot or a reference signal (RS) and by applying a similar step shown in 1210 of FIG. 11, each of the UEs 721, 722, and 723 may follow a similar approach illustrated above for the single UE scenario to determine the phase difference between the two RIS portions 732 and 734, respectively. The phase difference values determined by each of the UEs 721, 722, and 723 may be different for example due to different AoDs to different UEs as shown in FIG. 12. After estimating each of the phase differences the multiple UEs 721, 722 and 723 each receives the modulated signal in which the datα is modulated by MPSK or QAM modulation as described above, performs signal strength measurements, and estimates the phase value ϕₘ that is added to at least one RIS portion after compensating the phase difference. The phase difference may be estimated by sending the pilot or RS only or sending the pilot or RS with a known phase component value as described for the single UE scenario. It should be noted that while the source signal that is modulated by the RIS is considered to be a reference signal or a carrier signal, the source signal can also carry information. However, more advanced decoding can be carried at the destination to distinguish between the information from the source and information that is modulated by the RIS (e.g., from the sensor connected to the RIS). For example, if the source information is modulated with a constant envelope modulation, the destination can decode the source information and the information from the sensor in any order. However, if the source information is modulated with non-constant envelop modulation, the destination may need to sequentially decode the source information first and then the information from the sensor (that is modulated by the RIS) because the destination need to consider the change in amplitudes of the received signals when decoding the sensor information (that is modulated by the RIS). If the source information is sent to other destinations, the destination need not decode the source information when modulated with a constant envelop modulation but may need to decode the source information amplitude when modulated with a non-constant envelop modulation.

It should be noted that generally, the information determined at the UE, eitheπ by measurement or determined based on the measurements (e.g., information may be one or more of the following: RSs strengths, SNR, RSSI, RSRP, beam index, functions of the RSs strengths, UE AoA in DL, AoD in UL, UE orientation, UE location) may be sent to the base station, or another network equipment, via an uplink control channel such as physical uplink control channel (PUCCH), physical uplink shared channel (PUSCH), or another uplink channel.

Information at the base station, which may be either measurements (e.g., RSs measurements) or determined based on the measurements, may be sent by the base station, or another network equipment, as well as configuration information (e.g., updated beam directions and beam-width at the UE) to a UE through a DL channel such as physical downlink control channel (PDCCH), MAC (media access control or medium access control) signaling, or other DL signaling. Moreover, the base station, or another network equipment, may use radio resource control (RRC) signaling for configuration such as: configuring a UE for reference signaling (e.g., CSI-RS in DL or SRS in UL), RIS redirection commands, interferometer parameters (reference signals in multiple time-slots, RIS division, portions or parts, modulation scheme, . . , etc.) and other configurations for beam directions and beamwidths for different nodes, RIS location and size. Beam shape, antenna array pattern, number of antennas and other configuration information may be communicated through RRC signaling or UE category information.

In some embodiments, the OTA-interferometer based modulation may allow non-coherent modulation and/or decoding.

In some embodiments, the OTA-interferometer based modulation may be applicable to UEs with simple receivers such as envelope detectors.

In some embodiments, the OTA-interferometer based may be less sensitive to channel phase variation as in fast fading.

In some embodiments, the OTA-interferometer based modulation may be valid for RIS with low response time.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed:

1. A method, comprising:
receiving, by a reconfigurable intelligent surface (RIS), data for modulating a signal that impinges the RIS during each time slot of a plurality of time slots, wherein the RIS is divided into a plurality of RIS portions;
for each time slot of the plurality of time slots, determining phase components to be applied to the plurality of RIS portions, wherein at least one of the phase components to be applied to at least one RIS portion of the plurality of RIS portions comprises a first phase value for redirecting the signal from a transmitter to a receiver and a second phase value dependent on the data;
for each time slot of the plurality of time slots, applying the phase components to the plurality of RIS portions; and
redirecting the signal that impinges the RIS at each time slot of the plurality of time slots.

2. The method of claim 1, wherein the determining the phase components comprises:
adding a third phase value independent of the data that is different in each time slot of the plurality of time slots.

3. The method of claim 2, wherein the third phase value is added to the at least one RIS portion or at least one other RIS portion of the plurality of RIS portions.

4. The method of claim 1, further comprising:
receiving, by the RIS, configuration information for controlling the RIS during the plurality of time slots from a base station.

5. The method of claim 4, wherein the configuration information includes one or more of:
first phase information for one or more RIS elements in each RIS portion of the plurality of RIS portions;
a number of portions in the plurality of RIS portions;
a number of time slots in the plurality of time slots;
information related to the signal that impinges the RIS at each time slot of the plurality of time slots;
a modulation scheme that can be decoded by a user equipment (UE);
phase shift information for use in modifying phase values of at least one of the plurality of RIS portions with respect to at least one other of the plurality of RIS portions in each time slot of the plurality of time slots; or
a relative size of each RIS portion of the plurality of RIS portions.

6. A device, comprising:
one or more processors, when executing program instructions stored in the device, cause the device to perform operations:
receiving data for modulating a signal that impinges a reconfigurable intelligent surface (RIS) during each time slot of a plurality of time slots, wherein the RIS is divided into a plurality of RIS portions;
for each time slot of the plurality of time slots, determining phase components to be applied to the plurality of RIS portions, wherein at least one of the phase components to be applied to at least one RIS portion of the plurality of RIS portions comprises a first phase value for redirecting the signal from a transmitter to a receiver and a second phase value dependent on the data;
for each time slot of the plurality of time slots, applying the phase components to the plurality of RIS portions; and
redirecting the signal that impinges the RIS at each time slot of the plurality of time slots.

7. The device of claim 6, wherein the determining the phase components comprises:
adding a third phase value independent of the data that is different in each time slot of the plurality of time slots.

8. The device of claim 7, wherein the third phase value is added to the at least one RIS portion or at least one other RIS portion of the plurality of RIS portions.

9. The device of claim 6, wherein the operations further comprising:
receiving configuration information for controlling the RIS during the plurality of time slots from a base station.

10. The device of claim 9, wherein the configuration information includes one or more of:
first phase information for one or more RIS elements in each RIS portion of the plurality of RIS portions;
a number of portions in the plurality of RIS portions;
a number of time slots in the plurality of time slots;
information related to the signal that impinges the RIS at each time slot of the plurality of time slots;
a modulation scheme that can be decoded by a user equipment (UE);
phase shift information for use in modifying phase values of at least one of the plurality of RIS portions with respect to at least one other of the plurality of RIS portions in each time slot of the plurality of time slots; and
a relative size of each RIS portion of the plurality of RIS portions.

11. A method, comprising:
receiving, by a user equipment (UE), during each of a plurality of time slots, a plurality of signals, each signal being redirected by a portion of a reconfigurable intelligent surface (RIS) that is divided into a plurality of RIS portions, wherein a signal of the plurality of signals is modulated by a phase component, which comprises a first phase value, when the signal is redirected by at least one RIS portion of the plurality of RIS portions;
measuring, by the UE, a respective signal strength of the plurality of signals at each time slot of the plurality of time slots; and
determining, by the UE, based on the respective signal strength at each time slot of the plurality of time slots, the first phase value modulating the signal of the plurality of signals.

12. The method of claim 11, wherein the phase component used to modulate the signal redirected by the at least one RIS portion comprises the first phase value and a second phase value, wherein first phase values are the same in all of the plurality of time slots, and second phase values are different in each time slot of the plurality of time slots.

13. The method of claim 11, wherein another phase component of another signal of the plurality of signals redirected by at least one other of the RIS portions comprises a second phase value, and wherein second phase values are different in each time slot of the plurality of time slots.

14. The method of claim 11, further comprising:
receiving, by the UE, configuration information for measuring the plurality of signals via radio resource control (RRC) signaling.

15. The method of claim 14, wherein the configuration information includes one or more of:
a number of portions in the plurality of RIS portions;
a number of time slots in the plurality of time slots;
phase shift information for use in modifying phase values of at least one of the plurality of RIS portions with respect to at least one other of the plurality of RIS portions in each time slot of the plurality of time slots;
a modulation scheme that can be decoded by the UE;
a decoding rule for determining a phase value modulated on the plurality of signals based on the respective signal strength of each of the plurality of signals at each of the plurality of time slots;
information related to periodic pilot or reference signal transmission for RIS configuration update or a destination phase compensation and decoding rule; or
information related to periodic pilot transmission for interference patterns associated with each signal of the plurality of signals at each time slot of the plurality of time slots.

16. A device, comprising:
one or more processors, when executing program instructions stored in the device, cause the device to perform operations:
receiving during each of a plurality of time slots, a plurality of signals, each signal being redirected by a portion of a reconfigurable intelligent surface (RIS) that is divided into a plurality of RIS portions, wherein a signal of the plurality of signals is modulated by a phase component, which comprises a first phase value, when the signal is redirected by at least one RIS portion of the plurality of RIS portions;
measuring a respective signal strength of the plurality of signals at each time of the plurality of time slots; and
determining based on the respective signal strength at each time slot of the plurality of time slots, the first phase value modulating the signal of the plurality of signals.

17. The device of claim 16, wherein the phase component used to modulate the signal redirected by the at least one RIS portion comprises the first phase value and a second phase value, wherein first phase values are the same in all of the plurality of time slots, and second phase values are different in each time slot of the plurality of time slots.

18. The device of claim 16, wherein another phase component of another signal of the plurality of signals redirected by at least one other of the RIS portions comprises a second phase value, and wherein second phase values are different in each time slot of the plurality of time slots.

19. The device of claim 16, the operations further comprising:
receiving configuration information for measuring the plurality of signals via radio resource control (RRC) signaling.

20. The device of claim 19, wherein the configuration information includes one or more of:
a number of portions in the plurality of RIS portions;
a number of time slots in the plurality of time slots;
phase shift information for use in modifying phase values of at least one of the plurality of RIS portions with respect to at least one other of the plurality of RIS portions in each of the plurality of time slots;
a modulation scheme that can be decoded by the device;
a decoding rule for determining a phase value modulated on the plurality of signals based on the respective signal strength of each of the plurality of signals at each of the plurality of time slots;
information related to periodic pilot or reference signal transmission for RIS configuration update or a destination phase compensation and decoding rule; or
information related to periodic pilot transmission for interference patterns associated with each signal of the plurality of signals at each time slot of the plurality of time slots.
